(19) United States
(12) Patent Application Publication
(10) Pub. No.: US 2025/0173882 A1
(43) Pub. Date: May 29, 2025

(54) AUTOMATED DETECTION OF SENSOR OBSTRUCTIONS FOR MOBILE DIMENSIONING

(71) Applicant: ZEBRA TECHNOLOGIES CORPORATION, Lincolnshire, IL (US)

(72) Inventors: Raghavendra Tenkasi Shankar, Holbrook, NY (US); Patrick B. Tilley, Coram, NY (US)

(21) Appl. No.: 18/520,352

(22) Filed: Nov. 27, 2023

(51) Int. Cl. G06T 7/50; G06V 10/25; G06V 10/75; G06V 20/64

(52) U.S. Cl. CPC G06T 7/50; G06V 10/25; G06V 10/751; G06V 20/64

(57) ABSTRACT

A method includes: capturing, via a sensor of a computing device, a three-dimensional image corresponding to an object; detecting a region of interest in the three-dimensional image, the region of interest corresponding to an obstruction; determining a depth from the sensor to the region of interest; comparing the determined depth to a threshold; determining whether to deliver the three-dimensional image to a dimensioning module, based on the comparison of the depth of the obstruction with the threshold.

### BACKGROUND

Depth sensors such as time-of-flight (ToF) sensors can be deployed in mobile devices such as handheld computers, and employed to capture point clouds of objects (e.g., boxes or other packages), from which object dimensions can be derived. Obstructions in or near the field of view of a depth sensor, however, may reduce capture quality.

### BRIEF DESCRIPTION OF THE SEVERAL VIEWS OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a diagram of a computing device for dimensioning an object.

FIG. 2 is a diagram illustrating dimensioning artifacts introduced by proximate obstructions at the device of FIG. 1.

FIG. 3 is a flowchart of a method of automated detection of sensor obstructions for mobile dimensioning.

FIG. 4 is a diagram illustrating an example performance of blocks 305 and 310 of the method of FIG. 3.

FIG. 5 is a diagram illustrating an example performance of block 350 of the method of FIG. 3.

FIG. 6 is a diagram illustrating another example performance of block 350 of the method of FIG. 3.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

Examples disclosed herein are directed to a method including: capturing, via a sensor of a computing device, a three-dimensional image corresponding to an object; detecting a region of interest in the three-dimensional image, the region of interest corresponding to an obstruction; determining a depth from the sensor to the region of interest; comparing the determined depth to a threshold; determining whether to deliver the three-dimensional image to a dimensioning module, based on the comparison of the depth of the obstruction with the threshold.

Additional examples disclosed herein are directed to a computing device, comprising: a sensor; and a processor configured to: capture, via the sensor, a three-dimensional image corresponding to an object; detect a region of interest in the three-dimensional image, the region of interest corresponding to an obstruction; determine a depth from the sensor to the region of interest; compare the determined depth to a threshold; determining whether to deliver the three-dimensional image to a dimensioning module, based on the comparison of the depth of the obstruction with the threshold.

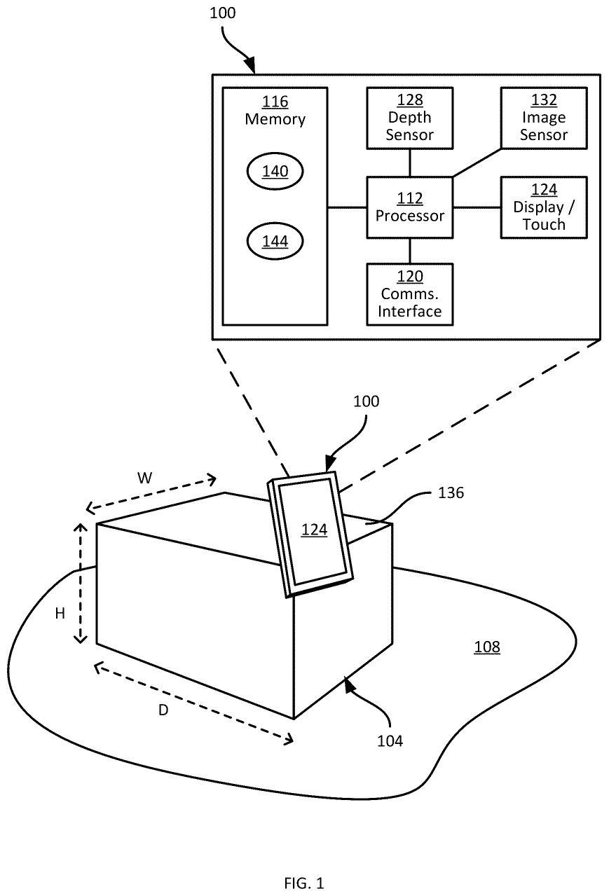

FIG. 1 illustrates a computing device 100 configured to capture sensor data depicting a target object 104 within a field of view (FOV) of one or more sensors of the device 100. The computing device 100, in the illustrated example, is a mobile computing device such as a tablet computer, smartphone, or the like. The computing device 100 can be manipulated by an operator thereof to place the target object 104 within the FOV(s) of the sensor(s), to capture sensor data for subsequent processing as described below. In other examples, the computing device 100 can be implemented as a fixed computing device, e.g., mounted adjacent to an area in which target objects 104 are placed and/or transported (e.g., a staging area, a conveyor belt, a storage container, or the like).

The object 104, in this example, is a parcel (e.g., a cardboard box, pallet, or the like), although a wide variety of other objects can also be processed as discussed herein. The sensor data captured by the device 100 can include a three-dimensional (3D) image (e.g., from which the device can generate a point cloud). In some examples, the sensor data captured by the device 100 can also include a two-dimensional (2D) image. To capture the three-dimensional image, the computing device 100 can be configured to capture a plurality of depth measurements, each corresponding to a pixel of a depth sensor. Each pixel can also include an intensity measurement, in some examples.

The depth measurements and sensor pixel coordinates can then be transformed, e.g., based on calibration parameters for the depth sensor, into a plurality of points forming a point cloud. Each point is defined by three-dimensional coordinates according to a predetermined coordinate system. The point cloud therefore defines three-dimensional positions of corresponding points on the target object 104 and any other objects within the FOV of the depth sensor, such as a support surface 108 supporting the object 104.

To capture a two-dimensional image, the computing device 100 can be configured to capture a two-dimensional array of pixels via an image sensor. Each pixel in the array can be defined by a color value and/or a brightness (e.g., intensity) value. For instance, the image can include a color image (e.g., an RGB image). As noted above, the three-dimensional image can also include intensity values for each pixel, and thus in some examples a two-dimensional image can also be derived from the same data set as the three-dimensional image.

The device 100 (or in some examples, another computing device such as a server, configured to obtain the sensor data from the device 100) can be configured to determine dimensions from the point cloud mentioned above, such as a width “W”, a depth “D”, and a height “H” of the target object 104. The dimensions determined from the point cloud can be employed in a wide variety of downstream processes, such as optimizing loading arrangements for storage containers, pricing for transportation services based on parcel size, and the like.

Certain internal components of the device 100 are also shown in FIG. 1. For example, the device 100 includes a processor 112 (e.g., a central processing unit (CPU), graphics processing unit (GPU), and/or other suitable control circuitry, microcontroller, or the like). The processor 112 is interconnected with a non-transitory computer readable storage medium, such as a memory 116. The memory 116 includes a combination of volatile memory (e.g. Random Access Memory or RAM) and non-volatile memory (e.g. read only memory or ROM, Electrically Erasable Programmable Read Only Memory or EEPROM, flash memory). The memory 116 can store computer-readable instructions, execution of which by the processor 112 configures the processor 112 to perform various functions in conjunction with certain other components of the device 100. The device 100 can also include a communications interface 120 enabling the device 100 to exchange data with other computing devices, e.g., via local and/or wide area networks, short-range communications links, and the like.

The device 100 can also include one or more input and output devices, such as a display 124, e.g., with an integrated touch screen. In other examples, the input/output devices can include any suitable combination of microphones, speakers, keypads, data capture triggers, or the like.

The device 100 further includes a depth sensor 128, controllable by the processor 112 to capture three-dimensional images and generate point cloud data therefrom, as set out above. The depth sensor 128 can include a time-of-flight (ToF) sensor, a stereo camera assembly, a LiDAR sensor, or the like. The depth sensor 128 can be mounted on a housing of the device 100, for example on a back of the housing (opposite the display 124, as shown in FIG. 1) and having an optical axis that is substantially perpendicular to the display 124. The device 100 can also include an image sensor 132 in some embodiments. The image sensor 132 can include a complementary metal-oxide semiconductor (CMOS) or charge-coupled device (CCD) camera, and can be controlled to capture two-dimensional images as noted above. Although the sensors 128 and 132 are described as physically separate sensors herein, in other examples the sensors 128 and 132 can be combined. The sensors 128 and 132 may therefore also be referred to as a sensor assembly, which can be either separate depth and image sensors, or a single combined sensor. For example, certain depth sensors, such as ToF sensors, can capture both three-dimensional images and two-dimensional images, by capturing intensity data along with depth measurements.

The depth sensor 128, when implemented as a ToF sensor, can include an emitter (e.g., an infrared laser emitter) configured to illuminate a scene, and a sensor (such as an infrared-sensitive image sensor) configured to capture reflected light from such illumination. The depth sensor 128 can further include a controller configured to determine a depth measurement for each captured reflection according to the time difference between illumination pulses and reflections. The depth measurement for a given pixel indicates a distance between the depth sensor 128 itself and the point in space where the reflection originated. Each depth measurement can therefore represent a point in a resulting point cloud. The depth sensor 128 and/or the processor 112 can be configured to convert the depth measurements into points in a three-dimensional coordinate system to generate the point cloud, from which dimensions of the object 104 can be determined.

For example, determining dimensions of the object 104 can include detecting the support surface 108 and an upper surface 136 of the object 104 in the point cloud. The height H of the object 104 can be determined as the perpendicular distance between the upper surface 136 and the support surface 108. The width W and the depth D can be determined as the dimensions of the upper surface 136. In other examples, the dimensions of the object 104 can be determined by detecting intersections between planes forming the surfaces of the object 104, by calculating a minimum hexahedron that can contain the object 104, or the like. Still further, irregularly shaped objects can be dimensioned from point cloud and depth images by an algorithm targeted at irregularly shaped objects.

Detection of the object 104 and dimensioning of the object 104 based on a point cloud captured via the depth sensor 128 can be affected by a wide variety of factors. An obstruction sufficiently close to the FOV of the sensor 128, such as a finger of an operator of the device 100, an item of clothing, or the like, can negatively affect dimensioning accuracy even if the obstruction does not block the object 104 itself from view relative to the sensor 128. For example, an obstruction sufficiently close to the sensor 128 may result in edges of the object 104 appearing distorted in the resulting point cloud, which in turn can lead to inaccurate dimensions being determined for the object 104. The device 100 therefore implements certain actions to suppress dimensioning of the object 104 based on three-dimensional images that are likely to contain proximate obstructions to the sensor 128.

The memory 116 stores computer readable instructions for execution by the processor 112. In particular, the memory 116 stores a pre-processing application 140 that, when executed by the processor 112, configures the processor 112 to process three-dimensional images captured via the depth sensor 128 to determine whether such images are likely to contain proximate obstructions (e.g., obstructions sufficiently close to the sensor 128 to distort other objects in the images, such as the object 104). The memory 116 also stores, in this example, a dimensioning application 144 (also referred to as a dimensioning module) that, when executed by the processor 112, configures the processor 112 to process point cloud data captured via the depth sensor assembly 128 to determine dimensions for objects in the images (e.g., the width, depth, and height shown in FIG. 1), such as the object 104.

The applications 140 and 144 are illustrated as distinct applications for illustrative purposes, but in other examples, the functionality of the applications 140 and 144 may be integrated in a single application. In further examples, either or both of the applications 140 and 144 can be implemented by one or more specially designed hardware and firmware components, such as FPGAs, ASICs and the like.

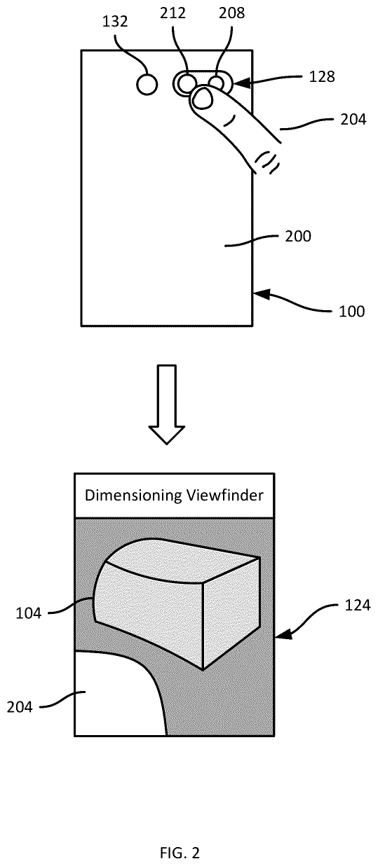

Referring to FIG. 2, an example scenario in which a partial proximate obstruction of the sensor 128 can distort portions of a captured three-dimensional image. A back surface 200 of the device 100 is illustrated, opposite the display 124. The sensors 128 and 132 are shown disposed on the back surface 200, with the sensor 128 partially obstructed, e.g., by a finger 204 of an operator of the device 100. The finger 204 may be resting against the back surface 200, for example as the operator holds the device 100. The sensor 128 includes, as mentioned above, an emitter 208 and a receiver 212. When the finger 204 partially obstructs the emitter 208, high-intensity reflections of light emitted by the emitter 208 may impact the receiver 212, due to the small distance from the emitter 208 to the finger 204. As seen in the lower portion of FIG. 2, which illustrates a viewfinder presented on the display 124, although the object 104 itself is not obstructed by the finger 204, certain portions of the object 104 appear distorted (e.g., curved, in this example) in the point cloud representation of the object 104 generated from depth measurements captured by the sensor 128, and dimensions obtained from a three-dimensional image containing such distortions are likely to be inaccurate.

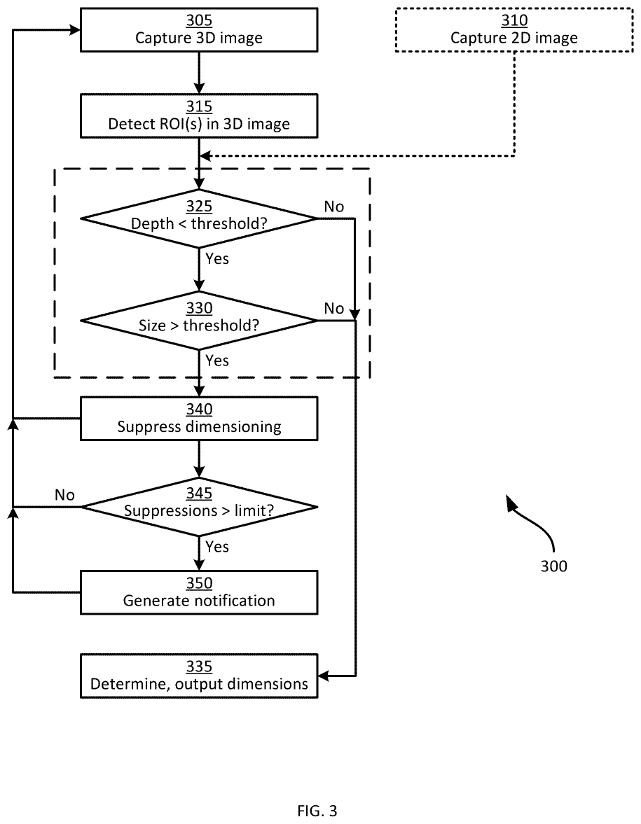

Turning to FIG. 3, a method 300 of automated detection of sensor obstructions for mobile dimensioning is illustrated. The method 300 is described below in conjunction with its performance by the device 100, e.g., to dimension the object 104. It will be understood from the discussion below that the method 300 can also be performed by a wide variety of other computing devices including or connected with depth sensors functionally similar to the sensor 128 mentioned in connection with FIG. 1.

At block 305, the device 100 is configured to capture a three-dimensional image, e.g., by capturing a plurality of depth measurements via the sensor 128 and generating a point cloud therefrom. In some examples, at block 310 the device 100 can also be configured to capture a two-dimensional image via the sensor 132, substantially simultaneously with block 305. The capture of a 2D image at block 310 is optional, and may be omitted in other embodiments. As discussed below, the two-dimensional image, captured from a different sensor (having a different position on the device 100, as seen in FIG. 2) can optionally be employed by the device 100 to select notifications to an operator of the device 100 when proximate obstructions are detected. The 3D image (and, if applicable, 2D) images captured at blocks 305 and 310 can be one of a sequence of captured images, e.g., at a suitable frame rate. Each captured image can be presented on the display 124, e.g., to implement an electronic viewfinder function as shown in FIG. 2.

At block 315, the device 100 is configured, via execution of the application 140, to detect one or more regions of interest (ROIs) in the 3D image. The ROIs detected at block 315 can correspond to the object 104 and the support surface 108, for example. When an obstruction such as the finger 204 shown in FIG. 2 is present, the ROIs detected at block 315 may also include an ROI corresponding to a candidate obstruction.

For example, at block 315 the processor 112 can be configured to execute one or more segmentation operations to detect the object 104 in the 3D image from block 305. Examples of such segmentation operations include machine-learning based segmentation models such as You Only Look Once (YOLO). Various other models can be used for segmentation, such as a region-based convolutional neural network (R-CNN), a Fast-CNN, plane fitting algorithms such as RANdom SAmple Consensus (RANSAC) or the like. Various other segmentation operations can also be employed at block 310, including thresholding operations, edge detection operations, region growing operations, and the like.

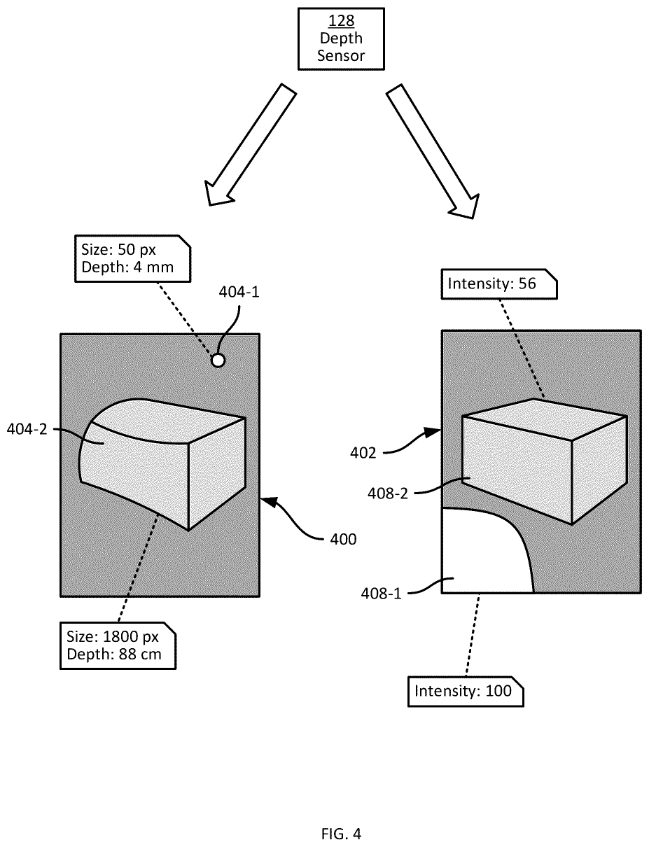

Turning to FIG. 4, an example 3D image 400 and an example 2D image are shown, both captured by the depth sensor 128 at block 305. For example, the depth sensor 128 can be a ToF sensor configured to capture both depth measurements and intensity values for each of a plurality of pixels. The 3D image 400 is shown in the form of a point cloud generated from the above-mentioned depth measurements. As seen in the 3D image 400, the object 104 is distorted as discussed above in connection with FIG. 2. The processor 112 can, at block 315, detect two ROIs 404-1 and 404-2 (collectively referred to as the ROIs 404, and generically referred to as an ROI 404) from the image 400. As seen from FIG. 4, the ROIs 404 correspond to regions in the image 400 with similar depths and/or intensities (e.g., where the differences in depth and/or intensity within an ROI 404 are smaller than the differences in depth and/or intensity between the ROI 404 and an adjacent portion of the image 400). The ROIs 404 therefore generally correspond to physical objects, and in this example the ROI 404-1 corresponds to the finger 204, while the ROI 404-2 corresponds to the object 104.

The processor 112 can also detect ROIs in the image 402, e.g., by applying 2D segmentation techniques to the intensity values captured by the sensor 128, by mapping the positions of the ROIs 404 detected from the 3D image to pixel coordinates of the sensor 128, or a combination thereof. In this example, the processor 112 detects a first ROI 408-1 in the image 402, corresponding to the finger 204 (and thus representing the same physical object as the ROI 404-1), and second ROI 408-2, corresponding to the object 104 (and thus corresponding to the same physical object as the ROI 404-2).

The processor 112 can also be configured to determine certain attributes of each ROI 404 and 408 detected at block 315. For example, as shown in FIG. 4, from the 3D image 400 the processor 112 can determine a size (e.g., an area in pixels corresponding to the pixel array of the sensor 128) of each ROI 404, and a depth indicating an average distance between the sensor 128 and the pixels representing the ROI 404. From the image 402, the processor 112 can determine an intensity indicating the average intensity or brightness of the pixels representing the ROIs 408. Thus, the processor 112 can determine at least the depth of each physical object in the FOV of the sensor 128, and may also determine a size and an intensity of each physical object as observed by the sensor 128. In other examples, the intensity measurements can be obtained from a separate sensor, such as the sensor 132.

At blocks 325 and 330, the device 100 can be configured to assess each ROI from block 315 to determine whether the ROI is likely to represent a proximate obstruction, such as the finger 204 shown in FIG. 2. At block 325, the processor 112 can be configured to determine whether a depth of the ROI 404 under consideration falls below a threshold. In other words, the processor 112 is configured to determine whether each ROI 404 corresponds to an object that is sufficiently close to the sensor 128 to potentially distort the object 104 and reduce the accuracy of dimensions determined for the object 104.

The determination at block 325 can include comparing the depth determined for each ROI 404 to a depth threshold, and determining whether the depth of each ROI 404 falls below the threshold. The threshold can be, for example, a minimum depth setting of the sensor 128, e.g., a manufacturer guideline or the like indicating a distance below which the sensor 128 may produce inaccurate results. For example, the depth threshold can be 20 cm in this example, although a wide variety of other depth thresholds can be applied for other sensors 128. As seen in FIG. 4, the ROI 404-2 has a depth exceeding the threshold, while the ROI 404-1 has a depth falling below the threshold. The determination at block 325 for the ROI 404-1 is therefore affirmative, and the determination at block 325 for the ROI 404-2 is negative.

In some examples, the determination at block 325 can include comparing an intensity of each ROI 408 to an intensity threshold, instead of or in addition to comparing a depth of the corresponding ROI 404 to the depth threshold. As noted above, proximate obstructions tend to cause high-intensity reflections at the receiver 212 of the sensor 128, and an ROI 408 with a high intensity may therefore indicate an obstruction sufficiently close to the sensor 128 to distort other objects in the image 400. For example, referring to FIG. 4, the intensities of the ROIs 408-1 and 408-2 have values of 100 and 56, respectively. As will be apparent, a wide variety of intensity ranges can be implemented, depending on the sensor 128 and the image format generated by the sensor 128; the values shown in FIG. 4 are purely illustrative. For a threshold of 80, for example, the determination at block 325 for the ROI 408-1 is affirmative, while the determination at block 325 for the ROI 408-2 is negative.

In some examples, both depth-based and intensity-based comparisons can be employed at block 325, and the determination at block 325 can be affirmative for a given ROI 404 and corresponding ROI 408 if either or both of the comparisons is affirmative (e.g., if the ROI 404 is sufficiently close to the sensor 128, and/or the corresponding ROI 408 is sufficiently bright).

When the determination at block 325 is negative for all ROIs 404 in the image 400, the device 100 can proceed to a dimensioning stage, described further below. When the determination at block 325 is affirmative for at least one ROI 404, as in the example of FIG. 4, the device 100 proceeds to block 330. At block 330, the processor 112 can be configured to determine whether a size of an ROI 404 for which the determination at block 325 was affirmative exceeds a threshold. In other words, ROIs 404 that exceed the depth threshold at block 325 need not be processed via block 330. In other examples, the size check at block 330 can be omitted.

The threshold can be predetermined, e.g., stored in the memory 140 as a component of the application 140, and can be selected to ignore visual artifacts such as small specular reflections, dust on a window of the sensor 128, or the like. For example, the threshold applied at block 325 may be ten pixels, and the determination at block 325 for the ROIs 404-1 and 404-2 is affirmative.

When the determination at block 330 is negative for all ROIs 404, the device 100 can proceed to a dimensioning stage. In particular, the processor 112 can proceed to block 335, to deliver the image 400 to the dimensioning application 144, which can in turn determine and output dimensions for the object 104. The dimensioning application 144 can be configured, as will be apparent to those skilled in the art, to identify the object 104 in the image 400 (e.g., based on the ROIs 404), to identify the surface 136 and the support surface 108, and determine the depth, width, and height of the object. The dimensions can then be presented on the display 124, transmitted to another computing device via the communications interface 120, or the like.

An affirmative determination at block 330 for at least one ROI 404, however, indicates that the image 400 contains an ROI 404 that is likely to represent a proximate obstruction. When the determination at block 330 is affirmative for at least one ROI 404, therefore, the device 100 proceeds to block 340. At block 340, the device 100 can suppress dimensioning of the image from block 305, e.g., by discarding the image 400 without passing the image 400 or any portion thereof to the dimensioning application 144. In some examples, the processor 112 can generate an inter-application notification from the application 140 to the application 144 indicating that a frame was dropped, e.g., if the application 144 relies on temporal filtering to generate dimensions from multiple frames, or if the application 144 otherwise requires notification of dropped frames.

As will now be apparent, based on the outcome of the determinations at blocks 325 and 330, the device 100 selects a handling action for the image 400, between suppressing dimensioning if the image 400 is likely to contain a proximate obstruction, and delivering the image 400 for dimensioning otherwise. The selection of a handling action as described above enables the device 100 to avoid producing inaccurate dimensions for the object 104 when it is likely that the object 104 is distorted due to a proximate obstruction such as the finger 204.

In addition, the device 100 can be configured to generate a notification under certain circumstances when an image from block 305 is discarded at block 340. In particular, at block 345, the processor 112 can be configured (e.g., via execution of the application 140) to determine whether a predetermined limit number of images have been suppressed from dimensioning at block 340. The limit can be defined as a threshold, e.g., maintained in the memory 116. For example, the limit may be five frames (although a wide variety of other limits can also be used). When the determination at block 345 is negative, the device 100 need not generate a notification, as the proximate obstruction may be present only briefly. When the determination at block 345 is affirmative, however, indicating that the proximate obstruction has been present for a threshold number of consecutive frames, the device 100 can proceed to block 350 to generate a notification, e.g., on the display 124 and/or via another output device.

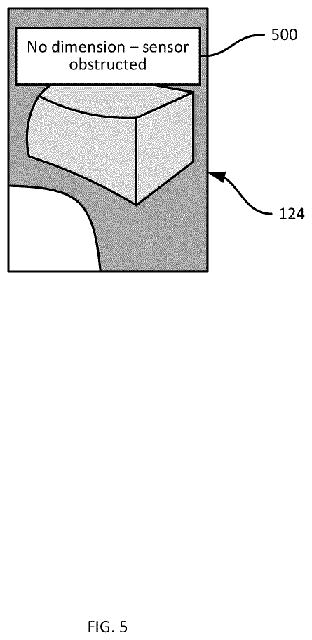

For example, as shown in FIG. 5, the device 100 can present a notification 500 on the display 124, advising an operator of the device 100 that the sensor 128 is obstructed and that dimensioning has therefore been suppressed.

In some examples, the 2D image captured via the sensor 132 at block 310 can be employed by the processor 112 to select a notification at block 350. The electronic viewfinder implemented by the device 100 can, for example, employ the 2D image(s) captured at block 310 rather than the 3D images from block 305. In some cases, due to the differing physical positions of the sensors 128 and 132 (as shown in FIG. 2), an obstruction to the sensor 128 may not obstruct the sensor 132, as in the case of the finger 204 shown in FIG. 2. If the electronic viewfinder is based on the images from the sensor 132, therefore, an operator of the device 100 may fail to notice, from the viewfinder on the display 124, that the sensor 128 is obstructed. The processor 112 can therefore be configured, for example, to determine whether the ROI 404-1 (or any other ROI 404 for which the determination at block 330 is affirmative) is within an FOV of the sensor 132.

The processor 112 can, for example, transform a position of the ROI 404-1 in a coordinate system of the sensor 128 to a position in a coordinate system of the sensor 132, e.g., based on a transform defined by calibration data stored in the memory 116. The calibration data can define the physical positions of the sensor 128 and the sensor 132 relative to one another. The calibration data can also include other sensor parameters, such as focal length, field of view dimensions, and the like. The calibration data can include, for example, an extrinsic parameter matrix and/or an intrinsic parameter matrix for each of the sensor 128 and the sensor 132.

The processor 112 can then determine whether the ROI 404-1 is within the FOV of the sensor 132 and would therefore appear in the 2D image from block 310. When the ROI 404-1 is expected to appear in the FOV of the sensor 132, the notification at block 350 may be omitted, as the obstruction will be visible on the display 124. When the ROI 404-1 is outside the FOV of the sensor 132, however, the device 100 can generate a notification at block 350 as described above.

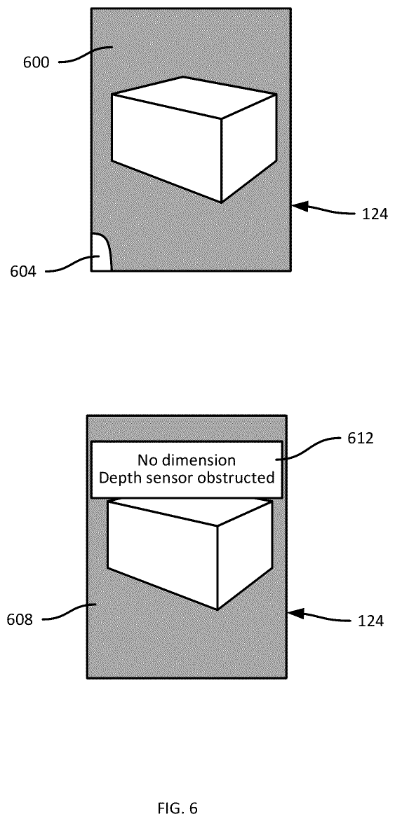

FIG. 6 illustrates example viewfinder control actions taken by the device 100 on the display 124 based in part on the determination above. For example, when the ROI 404-1 is at least partially within the FOV of the sensor 132, a 2D image 600 presented on the display 124, e.g., as an electronic viewfinder, includes a region 604 corresponding at least partially to the ROI 404-1. The device 100 may therefore omit the generation of a notification, as the obstruction is visible on the display 124 and the operator of the device 100 can be expected to remove the obstruction. When, on the other hand, the ROI 404-1 is outside of the FOV of the sensor 132, an image 608 from block 310 may not show any obstruction, and the device 100 may therefore generation a notification 612 at block 350.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

Certain expressions may be employed herein to list combinations of elements. Examples of such expressions include: “at least one of A, B, and C”; “one or more of A, B, and C”; “at least one of A, B, or C”; “one or more of A, B, or C”. Unless expressly indicated otherwise, the above expressions encompass any combination of A and/or B and/or C.

It will be appreciated that some embodiments may be comprised of one or more specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

1. A method, comprising:
capturing, via a sensor of a computing device, a three-dimensional image corresponding to an object;
detecting a region of interest in the three-dimensional image, the region of interest corresponding to an obstruction;
determining a depth from the sensor to the region of interest;
comparing the determined depth to a threshold;
determining whether to deliver the three-dimensional image to a dimensioning module, based on the comparison of the depth of the obstruction with the threshold.

2. The method of claim 1, wherein determining whether to deliver the three-dimensional image to the dimensioning module includes:
(i) suppressing delivery of the three-dimensional image to a dimensioning module when the depth is below the threshold, and
(ii) delivering the three-dimensional image to the dimensioning module, to obtain dimensions for the object, when the depth exceeds the threshold; and
executing the selected handling action.

3. The method of claim 1, wherein detecting the region of interest includes performing a segmentation operation on the three-dimensional image.

4. The method of claim 3, wherein detecting the region of interest further comprises:
determining a size of the region of interest; and
determining that the size exceeds a size threshold prior to determining the depth.

5. The method of claim 1, wherein the threshold corresponds to a minimum depth setting of the sensor.

6. The method of claim 1, further comprising:
in response to suppressing delivery of the three-dimensional image, determining whether delivery to the dimensioning module has been suppressed for a predetermined number of consecutive three-dimensional images; and
when delivery to the dimensioning module has been suppressed for the predetermined number of consecutive three-dimensional images, generating a notification via an output of the computing device.

7. The method of claim 6, further comprising:
capturing, via a second sensor, a two-dimensional image substantially simultaneously with the three-dimensional image; and
selecting the notification based on whether the two-dimensional image depicts at least a portion of the region of interest.

8. The method of claim 1, further comprising:
capturing, via the sensor, with the three-dimensional image, an intensity value associated with the region of interest;
comparing the intensity value to a second threshold; and
selecting the handling action based on the comparison of the depth with the threshold, and the comparison of the intensity with the second threshold.

9. The method of claim 8, wherein selecting the handling action further comprises:
when the depth exceeds the threshold and the intensity is below the second threshold, delivering the three-dimensional image to the dimensioning module.

10. A computing device, comprising:
a sensor; and
a processor configured to:
capture, via the sensor, a three-dimensional image corresponding to an object;
detect a region of interest in the three-dimensional image, the region of interest corresponding to an obstruction;
determine a depth from the sensor to the region of interest;
compare the determined depth to a threshold;
determining whether to deliver the three-dimensional image to a dimensioning module, based on the comparison of the depth of the obstruction with the threshold.

11. The computing device of claim 10, wherein the processor is configured to determine whether to deliver the three-dimensional image to the dimensioning module by:
(i) suppressing delivery of the three-dimensional image to a dimensioning module when the depth is below the threshold, and
(ii) delivering the three-dimensional image to the dimensioning module, to obtain dimensions for the object, when the depth exceeds the threshold; and
executing the selected handling action.

12. The computing device of claim 10, wherein the processor is configured to detect the region of interest by performing a segmentation operation on the three-dimensional image.

13. The computing device of claim 12, wherein the processor is configured to detect the region of interest by:
determining a size of the region of interest; and
determining that the size exceeds a size threshold prior to determining the depth.

14. The computing device of claim 10, wherein the threshold corresponds to a minimum depth setting of the sensor.

15. The computing device of claim 10, wherein the processor is configured to:
in response to suppressing delivery of the three-dimensional image, determine whether delivery to the dimensioning module has been suppressed for a predetermined number of consecutive three-dimensional images; and
when delivery to the dimensioning module has been suppressed for the predetermined number of consecutive three-dimensional images, generate a notification via an output of the computing device.

16. The computing device of claim 15, wherein the processor is configured to:
capture, via a second sensor, a two-dimensional image substantially simultaneously with the three-dimensional image; and
select the notification based on whether the two-dimensional image depicts at least a portion of the region of interest.

17. The computing device of claim 10, wherein the processor is configured to:
capture, via the sensor, with the three-dimensional image, an intensity value associated with the region of interest;
compare the intensity value to a second threshold; and
select the handling action based on the comparison of the depth with the threshold, and the comparison of the intensity with the second threshold.

18. The computing device of claim 17, wherein the processor is configured to select the handling action by:
when the depth exceeds the threshold and the intensity is below the second threshold, delivering the three-dimensional image to the dimensioning module.
